(19) United States
(12) Patent Application Publication
(10) Pub. No.: US 2015/0119494 A1
(43) Pub. Date: Apr. 30, 2015

(54) METHOD OF MANUFACTURING COMPOSITE MATERIAL HAVING NANO STRUCTURE GROWN ON CARBON FIBER AND COMPOSITE MATERIAL HAVING NANO STRUCTURE MANUFACTURED USING THE SAME

(71) Applicant: UNIST Academy-Industry Research Corporation, Ulsan (KR)

(72) Inventors: Hyung Wook PARK, Ulsan (KR); Deka Biplabkr, Ulsan (KR); Kyung II Kong, Busan (KR)

(21) Appl. No.: 14/495,961

(22) Filed: Sep. 25, 2014

(30) Foreign Application Priority Data
Oct. 30, 2013 (KR) 10-2013-0129665

(51) Int. Cl. C08K 9/02; B05D 3/06

(52) U.S. Cl. CPC C08K 9/02; B05D 3/068; B05D 2256/00; B05D 2350/30
USPC 523/210; 427/551

(57) ABSTRACT

Provided is a composite material having a nano structure grown on a carbon fiber with a high density. A method of manufacturing a composite material includes: modifying a surface of a carbon fiber by using an electron beam; growing a zinc oxide (ZnO) nano structure on the modified surface of the carbon fiber; and transferring the carbon fiber and the zinc oxide nano structure onto a polymer resin.

### CROSS-REFERENCE TO RELATED PATENT APPLICATIONS

This application claims the benefit of Korean Patent Application No. 10-2003-0129665, filed on Oct. 30, 2013, in the Korean Intellectual Property Office, the disclosure of which is incorporated herein in its entirety by reference.

### BACKGROUND OF THE INVENTION

1. Field of the Invention

The present invention relates to a method of manufacturing a composite material, and more particularly, to a method of manufacturing a composite material having a nano structure grown on a carbon fiber and a composite material having a nano structure manufactured using the same.

2. Description of the Related Art

Recently, fiber reinforced composite materials have relatively high strength, stiffness, and toughness and thus are used in various fields. These composite materials provide advantages but have essentially complicated configuration. Composite materials configured of strong fibers and an appropriate matrix are not necessarily strong. A main factor for determining the overall performance of composite materials is interfacial strength of a fiber and a matrix. The interfacial strength needs to be increased for a strong composite material, and there are attempts using alternating phases as a method for increasing the interfacial strength. In detail, there is a technology for growing micro-sized whisker, a nanowire, a nanotube on a surface of the matrix. This shape may cause an increase in a surface area for coupling a nano structure and the matrix and may reinforce load transfer as a nano structure protrudes and is inserted into the matrix. For example, in order to increase the surface area and the interfacial strength of the fiber, carbon nanotubes (CNTs), graphene oxides, various kinds of metal-oxide nanorods and nanowires may be widely grown on surfaces of carbon fibers (matrix).

Among various methods for achieving the above-described objective, a chemical functionalization method is frequently used to modify the surfaces of carbon fibers and thus, the carbon fibers may chemically react with the matrix surrounded by the carbon fibers. This modification may be performed by a grafting process or exposure to plasma, and chemical or electrochemical oxidation is more generally used. In recent studies, a method of directly growing CNTs on surfaces of carbon fibers by using chemical vapor deposition (CVD) has been suggested so as to increase a load transfer capacity of a composite material. Since this method is not dependent on a chemical reaction of a treated fiber and resin or affinity, performance of a final composite material is entirely irrelevant to a resin system.

An alternative attempt is to grow an array of zinc oxide (ZnO) nanowires that are rapidly aligned on the surfaces of the carbon fibers. This method includes a low temperature of less than about 90° C. and a liquid phase growth condition. Thus, an intrinsic fiber strength can be preserved, and there are several advantages compared to a method using CNTs or a silicon carbide. Surface areas of hybrid fibers may be increased by about 1000 times or more, and thus, interfacial shear strength of the hybrid fibers is increased by about 110% compared to that of bare fibers.

Even though a technology for growing nanorods on carbon fibers is relatively common, there are improvements for implementing a desired material property, because the growth of the nanorods on the carbon fibers and an interfacial adhesion force are strongly dependent on surface areas of fibers. The surface areas of the carbon fibers need to be relatively large so as to implement a fast growth of the nanorods and to implement strong coupling between the nanorods and the carbon fibers. In the related art, when the surface areas of the carbon fibers are increased, surface coupling characteristics of the fibers are lowered, and thus, the performance of the composite material may be degraded. Thus, a technology for further increasing the growth of the nanorods on the carbon fibers and for not degrading the performance of the composite material is required.

### SUMMARY OF THE INVENTION

The present invention provides a method of manufacturing a composite material having a nano structure grown on a carbon fiber with a high density.

The present invention also provides a composite material manufactured using the method.

According to an aspect of the present invention, there is provided a method of manufacturing a composite material, including: modifying a surface of a carbon fiber by using an electron beam; growing a zinc oxide (ZnO) nano structure on the modified surface of the carbon fiber; and transferring the carbon fiber and the zinc oxide nano structure onto a polymer resin.

In some embodiments, the modifying of the surface of the carbon fiber may be performed using a large pulsed electron beam (LPEB).

In some embodiments, the large pulsed electron beam (LPEB) may have a cathode voltage of 0 kV to 30 kV.

In some embodiments, the carbon fiber may include a woven carbon fiber (WCF).

In some embodiments, the growing of the zinc oxide nano structure may be performed by immersing the carbon fiber, of which surface is modified, in a solution for forming a zinc oxide.

In some embodiments, the solution for forming the zinc oxide may include a zinc oxide seed solution for forming a zinc oxide seed on the carbon fiber and a zinc oxide growth solution for growing a zinc oxide nano structure around the zinc oxide seed, and the growing of the zinc oxide nano structure may include: immersing the carbon fiber in the zinc oxide seed solution; and inserting the carbon fiber into an autoclave by immersing the carbon fiber in the zinc oxide growth solution.

The zinc oxide seed solution may be prepared using zinc acetate dihydrate (Zn(CH₃COO)₂2H₂O)), ethanol, and sodium hydroxide, and the zinc oxide growth solution may be prepared using zinc nitrate hexahydrate (Zn(NO₃)₂6H₂O)), hexamethylene tetramine (C₆H₁₂N₄), and distilled water.

The transferring of the carbon fiber and the zinc oxide nano structure onto the polymer resin may be performed using a vacuum-assisted resin transfer molding (VARTM) process.

According to another aspect of the present invention, there is provided a method of manufacturing a composite material, including: modifying a surface of a fiber; growing a nano structure on the modified surface of the fiber; and transferring the fiber and the nano structure onto a matrix.

According to another aspect of the present invention, there is provided a composite material manufactured using the above-described method.

### BRIEF DESCRIPTION OF THE DRAWINGS

The above and other features and advantages of the present invention will become more apparent by describing in detail exemplary embodiments thereof with reference to the attached drawings in which:

FIG. 1 is a flowchart illustrating a method of manufacturing a composite material according to an embodiment of the present invention;

FIG. 2 is a flowchart illustrating a method of manufacturing a composite material according to an embodiment of the present invention;

FIG. 3 is a schematic view illustrating a method of manufacturing a composite material according to an embodiment of the present invention;

FIG. 4 is a schematic view of a zinc oxide (ZnO) nano structure grown on a woven carbon fiber (WCF), of which surface is modified using a large pulsed electron beam (LPEB) in a method of manufacturing a composite material according to an embodiment of the present invention;

FIG. 5 is a graph showing X-ray diffraction analysis of a composite material according to an embodiment of the present invention;

FIG. 6 is a graph showing an electrical resistance of a composite material according to an embodiment of the present invention;

FIG. 7 is scanning electron microscope (SEM) images of surface morphology of a composite material according to an embodiment of the present invention; and

FIG. 8 is a graph showing impact absorbed energy of a composite material according to an embodiment of the present invention.

### DETAILED DESCRIPTION OF THE INVENTION

Hereinafter, exemplary embodiments of the present invention will be described in detail with reference to the accompanying drawings. The invention may, however, be embodied in many different forms and should not be construed as being limited to the embodiments set forth herein; rather, these embodiments are provided so that this disclosure will be thorough and complete, and will fully convey the concept of the invention to those skilled in the art. As used herein, the term “and/or” includes any and all combinations of one or more of the associated listed items. Like reference numerals denote like elements. Furthermore, various elements and regions in the drawings are schematically shown. Thus, the technical idea of the present invention is not limited by relative sizes or distances in the attached drawings.

The technical idea of the present invention is to manufacture a composite material and is directed to a method of increasing the growth of a nano structure on a carbon fiber or increasing an interfacial strength of the carbon fiber. In particular, the surface of the carbon fiber may be modified so as to increase the growth or interfacial strength of the carbon fiber.

In order to modify the surface of the carbon fiber, the surface area of the carbon fiber needs to be increased, and in particular, surface coupling characteristics need not to be lowered. Thus, non-destructive methods that do not affect interfacial coupling of carbon fibers need to be used, and a large pulsed electron beam (LPEB) technology may be used as an example of the non-destructive method. Although a continuous electron beam technology has been already used in various fields, the LPEB technology in units of micro-seconds is a new technology that has been recently suggested.

The LPEB technology uses a large beam having a relatively large diameter of about 60 mm on a surface of a target and having a high energy density. An energy pulse transferred by the LPEB is concentrated on a very thin layer of the surface of the target and is used to heat or cool the layer at a high temperature gradient. As the layer is heated or cooled at the high temperature gradient, the surface of the target may be modified, like melting, vaporization, ablation, and forming a white layer. The surface area of materials, such as woven carbon fibers (WCF), is increased through treatment using the LPEB, and thus, a strong interfacial interaction between a nano structure formed on the surface of the target and the carbon fiber is performed. Surface modification of the materials using the LPEB is an eco-friendly technology that may be applied to relatively large surface areas.

The present invention discloses manufacturing a composite material configured of a nano structure/fiber/polymer resin by modifying surfaces of fibers, such as carbon fibers, using a LPEB before zinc oxide (ZnO) nano structures are grown and subsequently, by growing nano structures on the surfaces of fibers, of which surfaces are modified and by transferring the fibers on which the nano structures are grown, onto a polymer resin, such as polyesther, by using a vacuum-assisted resin transfer molding (VARTM) process.

The surfaces of the fibers may be modified by various large pulsed electron beam voltages before the nano structures are grown. The effect of electron beam (E-beam) treatment regarding the growth of the nano structures and mechanical characteristics of the composite material may be analyzed by a change in electrical resistances, a change in surface morphology, X-ray diffraction, and a weight change.

Hereinafter, the usage of WCF as an example of the fiber, the usage of zinc oxide nano rods as an example of the nano structures, and the usage of polyesther as an example of the polymer material will be more specifically described. Also, the usage of the LPEB for surface modification of the fiber will be described as an example. However, this is provided only for illustrations, and aspects of the present invention are not limited thereto.

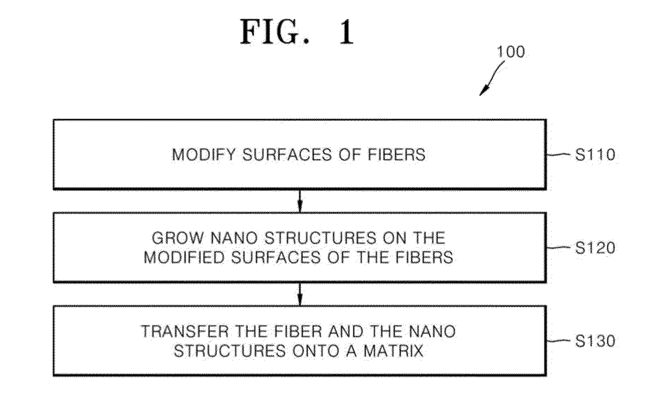

FIG. 1 is a flowchart illustrating a method (S100) of manufacturing a composite material according to an embodiment of the present invention.

Referring to FIG. 1, the method (S100) of manufacturing a composite material includes modifying surfaces of fibers (S110), growing nano structures on the modified surfaces of the fibers (S120), and transferring the fiber and the nano structures onto a matrix (S130).

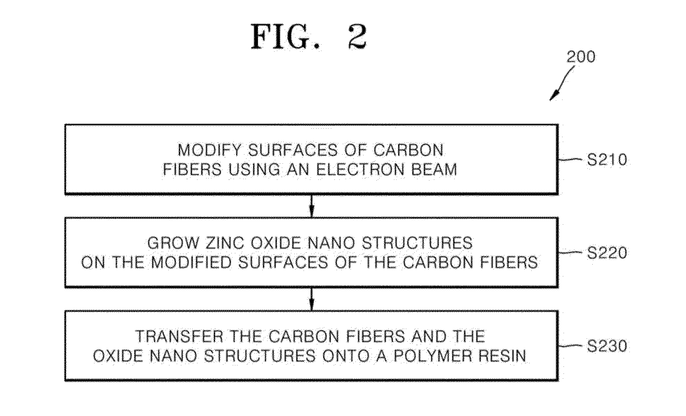

FIG. 2 is a flowchart illustrating a method (S200) of manufacturing a composite material according to an embodiment of the present invention.

The method (S200) of manufacturing a composite material includes modifying surfaces of carbon fibers using an electron beam (S210), growing zinc oxide nano structures on the modified surfaces of the carbon fibers (S220), and transferring the carbon fibers and the zinc oxide nano structures onto a polymer resin (S230).

Modifying the surfaces of the carbon fibers (S210) may be performed using a LPEB. The LPEB may have a cathode voltage of 0 kV to 30 kV. The carbon fibers may be woven carbon fibers (WCF). The carbon fibers suggested in the current embodiment are provided only for illustrations, and aspects of the present invention are not limited thereto, and graphene, carbon nano tubes (CNTs) or X-GNP is included in the technical idea of the present invention. Also, various fibers configured of different materials, instead of the carbon fibers are included in the technical idea of the present invention.

Growing the zinc oxide nano structures (S220) may be performed by immersing the carbon fibers, of which surfaces are modified, in a solution for forming a zinc oxide. The solution for forming the zinc oxide may include a zinc oxide seed solution used to form a zinc oxide seed on the carbon fibers and a zinc oxide growth solution used to grow zinc oxide nano structures on the carbon fibers around the zinc oxide seed.

The zinc oxide seed solution may be prepared using zinc acetate dihydrate (Zn(CH₃COO)₂2H₂O)), ethanol, and sodium hydroxide. The zinc oxide growth solution may be prepared using zinc nitrate hexahydrate (Zn(NO₃)₂6H₂O)), hexamethylene tetramine (C₆H₁₂N₄), and distilled water. Types and composition ratios of the zinc oxide seed solution and the zinc oxide growth solution, and their forming methods will be more specifically described below.

The zinc oxide nano structures may have various shapes, for example, nanorods, nanowires, nanotubes, nanoparticles, nanowalls, nanobelts, and nanorings. The zinc oxide nano structures may constitute an array in which zinc oxide nano structures are regularly arranged on the carbon fibers. For example, the zinc oxide nano structures may constitute a nanorod array structure in which zinc oxide nano structures are grown in a direction of one axis and are regularly arranged.

Also, a zinc oxide is an example as a material used for forming the nano structures suggested in the current embodiment, and aspects of the present invention are not limited thereto. Various nano structures configured of different materials, instead of the zinc oxide are included in the technical idea of the present invention.

Transferring the carbon fibers and the zinc oxide nano structures onto the polymer resin (S230) may be performed using a vacuum-assisted resin transfer molding (VARTM) process. The polymer resin may perform a function of a matrix of the composite material. The polymer resin may include various materials, for example, polyesther, polycarbonate, and polypropylene. However, this is provided only for illustrations, and aspects of the present invention are not limited thereto.

Hereinafter, exemplary Experimental Example of the present invention will be described. The following Experimental Example is provided only for illustrations, and aspects of the present invention are not limited thereto.

### Experimental Example

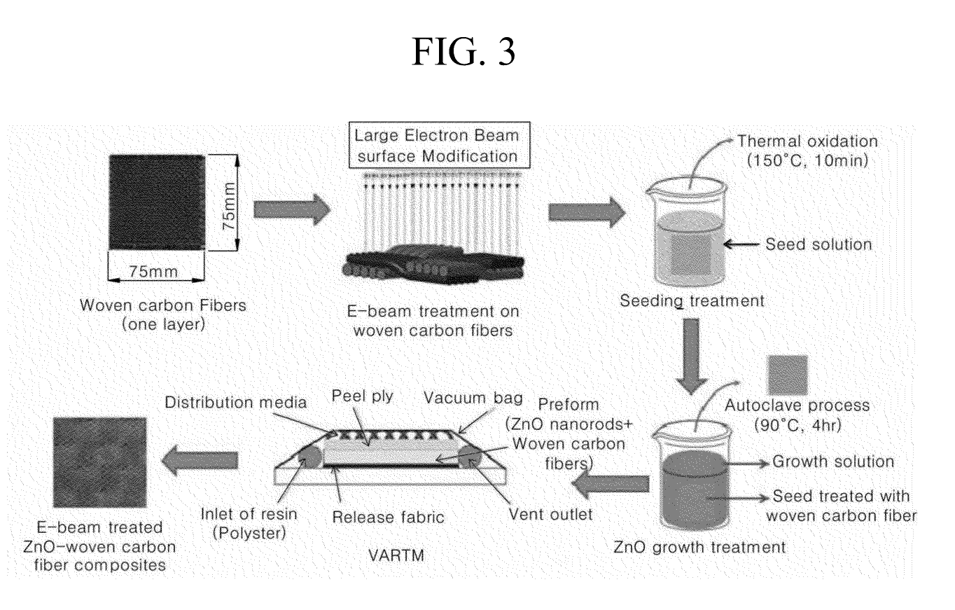

FIG. 3 is a schematic view illustrating a method of manufacturing a composite material according to an embodiment of the present invention. Experimental steps of FIG. 3 will now be described in detail.

Preparing Materials to be Used

T-300 grade woven carbon fibers that could be commercially obtained by Amoco Corporation (Chicago, Ill., USA) were used. Zinc acetate dihydrate (Zn(CH₃COO)₂2H₂O)), zinc nitrate hexahydrate (Zn(NO₃)₂6H₂O)), and hexamethylene tetramine (C₆H₁₂N₄) that could be commercially obtained by Sigma-Aldrich (St. Louis, Mo., USA) were used. Sodium hydroxide having an analysis grade that could be commercially obtained by Samchun Pure Chemical Co. Ltd., (Pyeongtaek, Korea) and ethanol that could be commercially obtained by J.T. Baker (Phillipsburg, N.J., USA) were used.

Large Pulsed Electron Beam Treatment of Woven Carbon Fiber Samples

Woven carbon fiber samples were prepared by cutting a woven carbon fiber sheet in the form of a square having 75 mm×75 mm. After the woven carbon fiber samples were cleaned using an ethanol solution, they were dried in an oven at about 100° C. for about 10 minutes. Subsequently, the woven carbon fiber samples were inserted into an electron beam apparatus (apparatus No. PF32A, Sodick Co. Ltd., Yokohama, Japan) so that surfaces of the woven carbon fiber samples could be modified. The surfaces of the woven carbon fiber samples were modified using a large pulsed electron beam.

While the surfaces of the woven carbon fiber samples were modified, a voltage of a solenoid of the electron beam apparatus was maintained at 1.5 kV, and a cathode voltage of the electron beam apparatus changed into 10 kV to 30 kV. The surface modification processes were performed in a standard cycle of four steps.

Woven shapes of the surfaces of the woven carbon fiber samples were more remarkably present by large pulsed electron beam treatment, and this will be described by the following scanning electron microscope (SEM) images.

Preparing Zinc Oxide Seed Solution

A zinc oxide (ZnO) seed solution for forming a zinc oxide seed was prepared using zinc acetate dihydrate, ethanol, and sodium hydroxide.

0.22 g of zinc acetate dihydrate was dissolved in 400 mL of ethanol at a temperature of 65° C. and was thoroughly stirred for 30 minutes. 2 mM of sodium hydroxide was dissolved in 80 mL of another ethanol solution at the temperature of 65° C. for 10 minutes. The ethanol solution in which zinc acetate dihydrate was dissolved, and the ethanol solution in which sodium hydroxide was dissolved, were mixed with each other. A total volume of 800 mL of a zinc oxide seed solution was prepared by adding 320 mL of an ethanol solution to the mixture. The zinc oxide seed solution was not heated but was thoroughly stirred for 30 minutes so as to guarantee overall and uniform mixture and then was maintained without being stirred for 1 hour and was cooled at a room temperature so that preparing the zinc oxide seed solution was completed. pH of the zinc oxide seed solution was maintained in the range of 5 to 6. The zinc oxide seed solution was a transparent solution and was present in the form of a suspension of zinc oxide particles.

A chemical reaction that occurs due to the usage of the zinc oxide seed solution is represented by the following Formulae 1 through 4.

Zn²⁺+4OH⁻<->[Zn(OH)₄]²⁻ <Formula 1>

[Zn(OH)₄]²⁻<->ZnO₂²⁻+2H₂O <Formula 2>

ZnO₂²⁻+2H₂O<->ZnO+2OH⁻ <Formula 3>

ZnO+OH<->ZnOOH⁻ <Formula 4>

The type and composition ratio of the above-described zinc oxide seed solution are provided only for illustrations, and aspects of the present invention are not limited thereto.

Preparing Zinc Oxide Growth Solution

A zinc oxide growth solution was prepared so as to grow zinc oxide nano structures having desired composition. The zinc oxide growth solution was formed using zinc nitrate hexahydrate, hexamethylene tetramine, and distilled water.

Zinc nitrate hexahydrate and hexamethylene tetramine were mixed at a mole ratio of 1:1. For example, in order to prepare 20 mM of a zinc oxide growth solution, 20 mM of hexamethylene tetramine was dissolved in 630 mL of distilled water, was stirred for 10 minutes and then, 20 mM of zinc nitrate was added to the mixture solution, and the entire solution was stirred for 30 minutes. pH of the zinc oxide growth solution was maintained in the range of 6 to 8. The zinc oxide growth solution was used to grow the zinc oxide nano structures on woven carbon fibers (WCF), of which surfaces were modified.

Chemical reactions of growth and synthesis of the zinc oxide that occur due to the usage of the zinc oxide growth solution are represented by the following Formulae 5 to 7.

C₆H₁₂N₄+6H²O<->6HCHO+4NH₃ <Formula 5>

NH₃+H₂O<->NH₄⁺+OH⁻ <Formula 6>

2OH⁻+Zn²⁺<->ZnO+H₂O <Formula 7>

The type and composition ratio of the above-described zinc oxide growth solution are provided only for illustrations, and aspects of the present invention are not limited thereto.

Forming Zinc Oxide Seed

Woven carbon fiber samples on which large pulsed electron beam treatment was performed, were immersed in the above-described zinc oxide seed solution for 10 minutes, and subsequently, were annealed, i.e., thermally oxidized at 150° C. for 10 minutes so as to remove a solvent and other organic materials. Immersion in the zinc oxide seed solution and annealing were repeatedly performed a plurality of times, and in the current experiment, four times.

Forming Oxide Nano Structure

The carbon fiber samples, of which surfaces were modified and on which seeds were formed, were immersed in the zinc oxide growth solution, and the carbon fiber samples in the immersed state were inserted into a stainless steel autoclave and were sealed and then, were maintained in the autoclave at a temperature of 90° C. for 4 hours. Thus, a hydrothermal reaction in which zinc oxide zinc oxide nano structures were formed around the zinc oxide seed formed on the surface of the carbon fiber in the zinc oxide growth solution was performed.

Subsequently, the carbon fiber samples were discharged from the autoclave and were cleaned with distilled water for about 20 minutes so that the growth of the zinc oxide nano structures was finished. Woven carbon fiber samples having the zinc oxide nano structures that were finally synthesized, were naturally dried for 1 hour.

Manufacturing Composite Material

A composite material having the configuration of zinc oxide nano structure/carbon fiber/polymer resin was manufactured. A vacuum-assisted resin transfer molding (VARTM) process was used to form the composite material. A polyesther resin was used as the polymer resin. The polymer resin could be put onto the carbon fiber and could be filled among zinc oxide nano structures.

Manufacturing Composite Material According to Comparative Example

A composite material according to Comparative Example was formed by not modifying surfaces of woven carbon fibers by using an electron beam but by forming zinc oxide nano structures on the surfaces of the woven carbon fibers in the same manner as the above-described manner. That is, the composite material according to Comparative Example was formed in the same manner as the above-described manner except that electron beam surface modification was not performed.

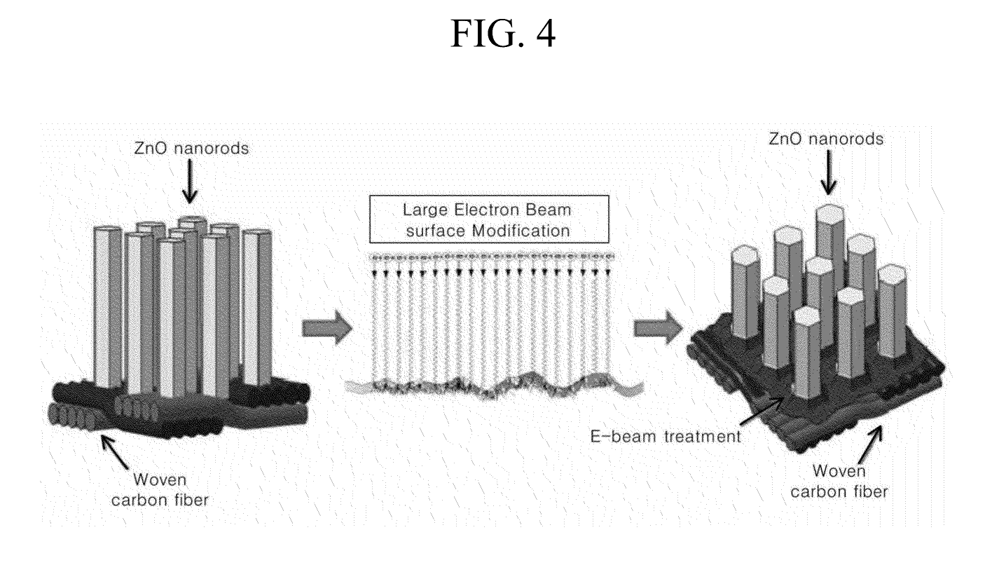

FIG. 4 is a schematic view of zinc oxide nano structures grown on woven carbon fibers, of which surfaces are modified using a large pulsed electron beam (LPEB) in a method of manufacturing a composite material according to an embodiment of the present invention.

Zinc oxide nano structures formed on woven carbon fibers, of which surfaces are not modified, and zinc oxide nano structures formed on woven carbon fibers, of which surfaces are modified using an electron beam are shown in FIG. 4. The shape of the zinc oxide nano structures formed on woven carbon fibers, of which surfaces are not modified, may be similar to that of the zinc oxide nano structures formed on woven carbon fibers, of which surfaces are modified. However, as the surfaces of the woven carbon fibers are modified by the electron beam, the surfaces may be rugged or rough or may have an electrochemically-unstable energy state. Thus, more nucleus generation positions may be provided to form the zinc oxide nano structures, or the growth of the zinc oxide may be increased. Thus, the zinc oxide nano structures formed on the woven carbon fibers, of which surfaces are modified, may have different characteristics from those of the zinc oxide nano structures formed on the woven carbon fibers, of which surfaces are not modified. Hereinafter, these different characteristics will be described in detail.

Difference in Weights of Zinc Oxide Nano Structures

Table 1 shows a difference in weights of zinc oxide nano structures manufactured according to an embodiment of the present invention. All 20 mL of a zinc oxide growth solution was used.

TABLE 1

| | Weight | Weight | | |
|---|---|---|---|---|
| | (g) before | (g) after | | Weight |
| Classification of samples | nano | nano | Change | change |
| according to formation | structures | structures | (g) in | ratio |
| conditions | are formed | are formed | weights | (%) |
| Woven carbon fiber + zinc | 1.5911 | 1.5942 | 0.0031 | 0.195 |
| oxide seed solution + zinc | | | | |
| oxide growth solution | | | | |
| Woven carbon fiber + 10 kV | 1.5481 | 1.5535 | 0.0054 | 0.348 |
| electron beam treatment + | | | | |
| zinc oxide seed solution + | | | | |
| zinc oxide growth solution | | | | |
| Woven carbon fiber + 20 kV | 1.6139 | 1.6217 | 0.0078 | 0.483 |
| electron beam treatment + | | | | |
| zinc oxide seed solution + | | | | |
| zinc oxide growth solution | | | | |
| Woven carbon fiber + 30 kV | 1.5892 | 1.5985 | 0.0093 | 0.585 |
| electron beam treatment + | | | | |
| zinc oxide seed solution + | | | | |
| zinc oxide growth solution | | | | |

Referring to Table 1, since the woven carbon fiber samples became heavy after the zinc oxide nano structures were grown on the woven carbon fibers, a change in weights occurred. The change in weights is associated with the forming amount of the zinc oxide nano structures. A weight change ratio in the case where the surfaces of the woven carbon fibers were modified by the electron beam, was larger than the case where electron beam surface modification treatment was not performed. It is analyzed that a difference in the weight change ratios occurs because more zinc oxide nano structures are rapidly generated and grown due to electron beam surface modification treatment.

As the cathode voltage applied from the electron beam apparatus changed from 10 kV to 30 kV, weight change ratios of the woven carbon fiber samples were increased. A maximum value of the weight change ratios of the woven carbon fiber samples was 0.585% at the cathode voltage of 30 kV. It is analyzed that, as the cathode voltage is increased, the area of the modified surfaces of the woven carbon fibers, i.e., the area in which zinc oxide nano structures are to be formed, is maximized and thus more rapid generation and growth of more zinc oxide nano structures are induced.

X-Ray Diffraction Analysis

Samples of Table 1 were analyzed by X-ray diffraction. The X-ray diffraction analysis was performed using a wide width angle X-ray diffraction device manufactured by Bruker Corporation (Billerica, Mass., USA). Conditions for diffraction analysis were an operating voltage of 40 kV and a current of 20 mA, and a crystal monochromator for CuK α radiation was used in the range of 5° to 60° (2θ).

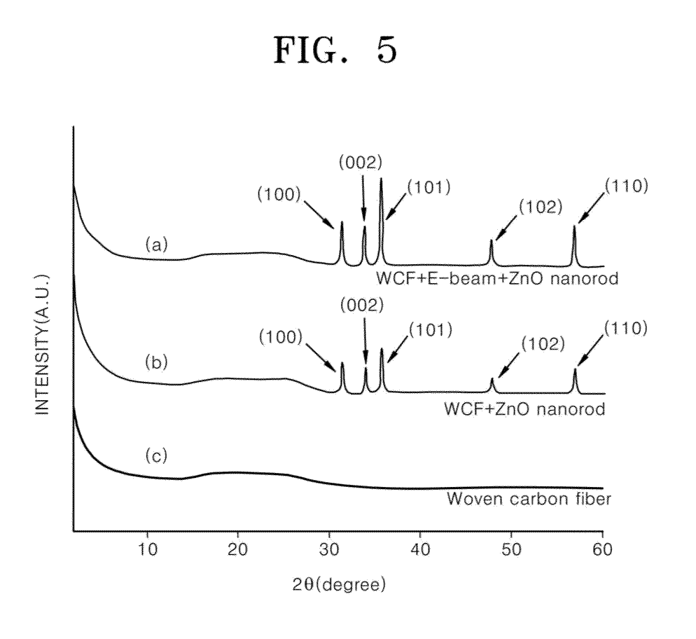

FIG. 5 is a graph showing X-ray diffraction analysis of a composite material according to an embodiment of the present invention. (a) shows the case where the composite material includes zinc oxide nano structures grown on woven carbon fibers, of which surfaces are modified by an electron beam, and (b) shows the case where the composite material includes zinc oxide nano structures grown on woven carbon fibers, of which surfaces are not modified by the electron beam, and (c) shows woven carbon fibers in which no zinc oxide nano structures are formed.

Referring to FIG. 5, no remarkable diffraction peaks occur in woven carbon fibers in which no zinc oxide nano structures are formed (see (c)). On the other hand, when zinc oxide nano structures are formed (see (a) and (b)), diffraction peaks corresponding to (100), (002), (101), (102), and (110) crystal faces occur at 30° or more. It is analyzed that the diffraction peaks are formed by the zinc oxide nano structures.

The diffraction peaks occurred in the same positions comparing the case where the woven carbon fibers were LPEB surface modification treated with the case where the woven carbon fibers were not LPEB surface modification treated. On the other hand, when the woven carbon fibers were treated by LPEB surface modification, intensity of the diffraction peaks was higher compared to that of the diffraction peaks when the woven carbon fibers were not LPEB surface modification treated. Since a higher intensity of the diffraction peaks is proportional to the amount of a material that generates the diffraction peaks, the amount (or density) of the zinc oxide nano structures formed on the woven carbon fibers that are LPEB surface modification treated is larger than that of the zinc oxide nano structures formed on the woven carbon fibers that are not LPEB surface modification treated. That is, it is analyzed that more rapid generation and growth of more zinc oxide nano structures formed on the woven carbon fibers that are LPEB surface modification treated are induced so that the density of the zinc oxide nano structures is increased. The result of X-ray diffraction coincides with the result of the above-described change in weights.

Electrical Resistance Analysis Electrical resistances of the samples of Table 1 were measured. 2002 multi-meter manufactured by Keithley Instruments (Beachwood, Ohio, USA) was used to perform electrical resistance measurement.

According to the conventional studies, it is known that, if zinc oxide nano structures are grown on woven carbon fibers, the entire electrical conductivity is reduced. The reduction in electrical conductivity occurs, because oxygen included in the zinc oxide nano structures serves as a barrier wall for electron movement and blocks the flow of a current. Thus, the more zinc oxide nano structures are included in the samples, the entire electrical resistance of the samples is increased.

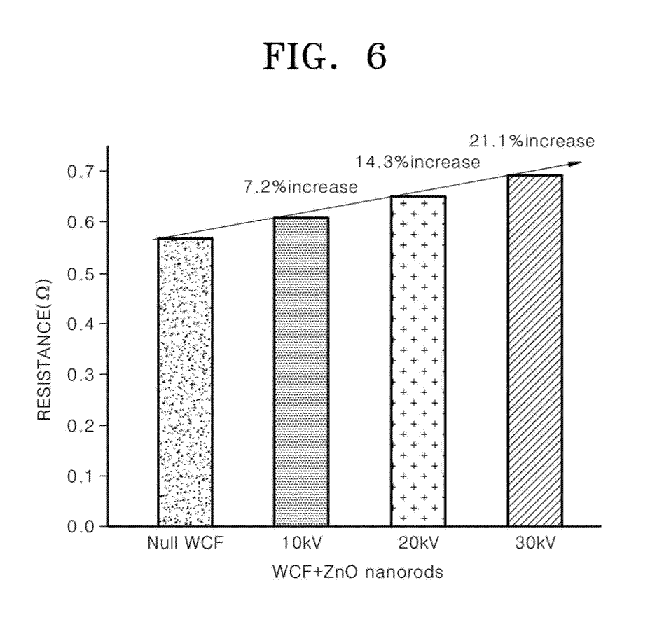

FIG. 6 is a graph showing an electrical resistance of a composite material according to an embodiment of the present invention.

The graph of FIG. 6 shows an electrical resistance of a composite material having zinc oxide nano structures grown on woven carbon fibers that are not LPEB surface modification treated, and an electrical resistance of a composite material having zinc oxide nano structures grown on woven carbon fibers that are LPEB surface modification treated. The graph of FIG. 6 also shows an electrical resistance measured when the cathode voltage changes.

Referring to FIG. 6, when the woven carbon fibers are not LPEB surface modification treated, an electrical resistance is the lowest. On the other hand, when the woven carbon fibers are LPEB surface modification treated, the electrical resistance is increased. It is analyzed that, when the woven carbon fibers are LPEB surface modification treated, more rapid generation and growth of more zinc oxide nano structures are induced and the density of the zinc oxide nano structures is increased. The result of the electrical resistance coincides with the above-described X-ray diffraction result and the above-described result of the change in weights.

In detail, compared to the case where the woven carbon fibers are not LPEB surface modification treated, when the cathode voltage is 10 kV, the electrical resistance is increased by 7.2%, and when the cathode voltage is 20 kV, the electrical resistance is increased by 14.3%, and when the cathode voltage is 30 kV, the electrical resistance is increased by 21.1%. It is analyzed that this increase results from an increase in the surface area for generating and growing the zinc oxide nano structures on the woven carbon fibers as the cathode voltage is increased and thus an increase in the growth of the zinc oxide nano structures.

Surface Morphology Analysis

Surface morphology of the samples of Table 1 was observed. Nanonova 230 scanning electron microscope manufactured by FEI Corporation (Hillsboro, Oreg., USA) was used to observe the surface morphology. In this case, an operating voltage was 15 kV.

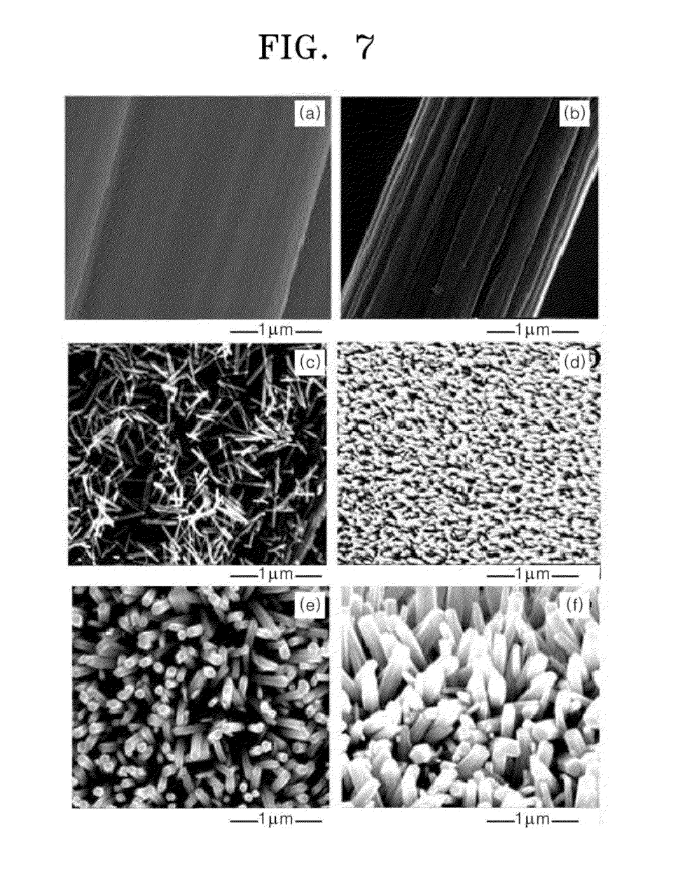

FIG. 7 is scanning electron microscope (SEM) images of surface morphology of a composite material according to an embodiment of the present invention.

In FIG. 7, (a) is a SEM image of woven carbon fibers that are not LPEB surface modification treated, and (b) is a SEM image of woven carbon fibers that are LPEB surface modification treated, and (c) is a SEM image of zinc oxide nano structures grown on the woven carbon fibers that are not LPEB surface modification treated, and (d), (e), and (f) are SEM images of zinc oxide nano structures grown on the woven carbon fibers that are LPEB surface modification treated. Here, (d) shows the case where the cathode voltage is 10 kV, and (e) shows the case where the cathode voltage is 20 kV, and (f) shows the case where the cathode voltage is 30 kV.

Referring to FIG. 7, as known by comparing (a) with (b), morphology of the surface of the woven carbon fibers that are not surface modification treated is more flat than that of the surface of the woven carbon fibers that are surface modification treated. The woven carbon fibers that are surface modification treated have a relatively three-dimensional surface shape, such as a remarkable woven shape.

Referring to FIG. 7, as known by comparing (c) through (f), the growth of the zinc oxide nano structures on the woven carbon fibers that are not treated surface modification is relatively lower than that of the zinc oxide nano structures on the woven carbon fibers that are surface modification treated. It is analyzed that this results from the woven carbon fibers that are not surface modification treated and do not provide sufficient surface areas for generation and growth of the zinc oxide nano structures. The surface morphology result coincides with the above-described electrical resistance result, the above-described X-ray diffraction result, and the above-described result of the change in weights.

Referring to FIG. 7, as known by comparing (d) through (f), when the woven carbon fibers are surface modification treated, as the applied cathode voltage is increased, the growth of the zinc oxide nano structures shows increased morphology and is densest at 30 kV. It is analyzed that this is because, after the woven carbon fibers are surface modification treated using a large pulsed electron beam, the surface areas of the woven carbon fibers for generation and growth of the zinc oxide nano structures are increased and a strong interaction between the modified surfaces of the woven carbon fibers and the zinc oxide nano structures is induced. The surface morphology result coincides with the above-described electrical resistance result, the above-described X-ray diffraction result, and the above-described result of the change in weights.

Impact Energy Absorption Analysis

Impact experiments were carried out so as to analyze impact energy absorption of the samples of Table 1.

The impact experiments were carried out using an impact experiment apparatus (5982) manufactured by Instron Corporation (Norwood, Mass., USA) on woven carbon fiber composite materials that are surface modification treated using a LPEB. A circular clamp having a diameter of 40 mm was used to fix the samples for the impact experiments. Data from an impact contact point until penetration of the samples was generated were collected using a photoelectric sensor.

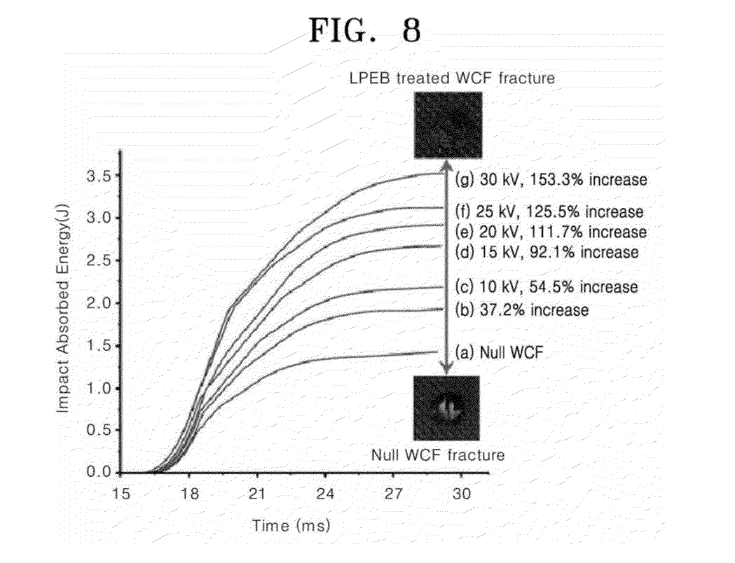

FIG. 8 is a graph showing impact absorbed energy of a composite material according to an embodiment of the present invention.

In FIG. 8, (a) is woven carbon fibers that are not LPEB surface modification treated, and (b) is zinc oxide nano structures grown on the woven carbon fibers that are not LPEB surface modification treated, and (c), (d), (e), (f), and (g) are zinc oxide nano structures grown on the woven carbon fibers that are LPEB surface modification treated. Here, (c) shows the case where the cathode voltage is 10 kV, and (d) shows the case where the cathode voltage is 15 kV, and (e) shows the case where the cathode voltage is 20 kV, and (f) shows the case where the cathode voltage is 25 kV, and (g) shows the case where the cathode voltage is 30 kV.

The entire impact energy is the sum of rebound energy and absorbed energy. Since rebound energy of a fragile composite material is negligibly small, the entire impact energy is almost the same as energy absorbed into a medium. In impact at a low speed, bending deformation energy and delamination energy are included in absorbed energy. However, due to fragile characteristics of the composite material, energy is mainly absorbed by carbon fiber destruction. For example, residual energy, such as the entire deformation, delamination, and shear destruction energy, is absorbed by impact.

Referring to FIG. 8, the woven carbon fibers that are not treated by LPEB surface modification show the smallest impact energy absorption. When zinc oxide nano structures are formed on the woven carbon fibers that are not LPEB surface modification treated, impact energy absorption was increased by about 37.2%.

On the other hand, when the zinc oxide nano structures are formed on the woven carbon fibers that are LPEB surface modification treated, impact energy absorption was further increased and also was increased proportional to a magnitude of a cathode voltage. For example, when the cathode voltage was 10 kV, an increase in impact energy absorption was 54.4%, and when the cathode voltage was 15 kV, an increase in impact energy absorption was 92.1%, and when the cathode voltage was 20 kV, an increase in impact energy absorption was 111.7%, and when the cathode voltage was 25 kV, an increase in impact energy absorption was 125.5%, and when the cathode voltage was 30 kV, an increase was 153.3%.

It is analyzed that the tendency of impact energy absorption results from an interaction between the zinc oxide nano structures and a matrix formed of a polymer material. The woven carbon fibers that are LPEB surface modification treated, have larger surface areas. Thus, generation and growth of the zinc oxide nano structures are performed on a large scale at a high speed. As a result, the amount of the zinc oxide nano structures is increased, and the strength of the interaction can be increased. Due to the interaction that occurs together with the polymer resin matrix, the composite material absorbs more delamination energy through the woven carbon fibers.

Also, the surfaces of the carbon fibers naturally include functional groups, such as a hydroxyl group, a carbonyl group, and a carboxyl group. These functional groups have very strong affinity with the zinc oxide nano structures. For example, carboxylic acid on the surfaces of the woven carbon fibers may react with zinc ions of the zinc oxide nano structures and may constitute a strong ionic bond. Also, the presence of two lone pairs of electrons of the carboxyl group may constitute strong affinity with the zinc oxide nano structures. These functional groups may constitute a strong bond due to a reaction with an esther group in a polyesther resin. An interaction of the functional groups, such as the woven carbon fibers, the zinc oxide nano structures, and the polyesther resin, may increase the impact strength of the final composite material.

### CONCLUSION

A method of manufacturing a composite material according to the technical idea of the present invention provides woven carbon fiber/zinc oxide nano structure/polyesther resin hybrid composite materials. The composite materials have been developed using LPEB surface modification treatment and a VARTM process. Before zinc oxide nano structures are grown, the surfaces of the woven carbon fibers have been modified using an LPEB. SEM images of the surfaces of the woven carbon fibers show growth steps of the zinc oxide nano structures that are performed subsequent to electron beam treatment. The zinc oxide nano structures have been most grown after electron beam treatment has been performed at the cathode voltage of 30 kV. In X-ray diffraction of the zinc oxide nano structures, an intensity of crystallinity peaks was the highest when the woven carbon fibers are LPEB treated. Also, when the woven carbon fibers are LPEB treated, a change in weights and an electrical resistance were also high. Electrical resistances of the composite materials were increased by 21.1% as an applied voltage for LPEB treatment was increased by 0 kV to 30 kV. When the woven carbon fibers were LPEB treated, impact energy absorption was increased by 153.3%. Samples that are LPEB treated showed stronger impact resistivity due to a strong mutual coupling between zinc oxides, carbon fibers, and a polyesther resin.

The above-described effects of the present invention have been described for illustrations, and the scope of the present invention is not limited by the effects.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a composite material, comprising: modifying a surface of a carbon fiber by using an electron beam; growing a zinc oxide (ZnO) nano structure on the modified surface of the carbon fiber; and transferring the carbon fiber and the zinc oxide nano structure onto a polymer resin.

2. The method of claim 1, wherein the modifying of the surface of the carbon fiber is performed using a large pulsed electron beam (LPEB).

3. The method of claim 2, wherein the large pulsed electron beam (LPEB) has a cathode voltage of 0 kV to 30 kV.

4. The method of claim 1, wherein the carbon fiber comprises a woven carbon fiber (WCF).

5. The method of claim 1, wherein the growing of the zinc oxide nano structure is performed by immersing the carbon fiber, of which surface is modified, in a solution for forming a zinc oxide.

6. The method of claim 5, wherein the solution for forming the zinc oxide comprises a zinc oxide seed solution for forming a zinc oxide seed on the carbon fiber and a zinc oxide growth solution for growing a zinc oxide nano structure around the zinc oxide seed, and the growing of the zinc oxide nano structure comprises: immersing the carbon fiber in the zinc oxide seed solution; and inserting the carbon fiber into an autoclave by immersing the carbon fiber in the zinc oxide growth solution.

7. The method of claim 6, wherein the zinc oxide seed solution is prepared using zinc acetate dihydrate (Zn(CH₃COO)₂2H₂O)), ethanol, and sodium hydroxide, and the zinc oxide growth solution is prepared using zinc nitrate hexahydrate (Zn(NO₃)₂6H₂O)), hexamethylene tetramine (C₆H₁₂N₄), and distilled water.

8. The method of claim 1, wherein the transferring of the carbon fiber and the zinc oxide nano structure onto the polymer resin is performed using a vacuum-assisted resin transfer molding (VARTM) process.

9. A composite material manufactured using the method of claim 1.

10. A method of manufacturing a composite material, comprising: modifying a surface of a fiber; growing a nano structure on the modified surface of the fiber; and transferring the fiber and the nano structure onto a matrix.

11. A composite material manufactured using the method of claim 10.
